(19) United States
(12) Patent Application Publication
(10) Pub. No.: US 2024/0000015 A1
(43) Pub. Date: Jan. 4, 2024

(54) SYSTEM AND METHOD FOR AUTOMATIC TOPPER CONTROL FOR AN AGRICULTURAL HARVESTER

(71) Applicants: CNH INDUSTRIAL BRASIL LTDA., Nova Lima (BR); CNH INDUSTRIAL AMERICA LLC, New Holland, PA (US)

(72) Inventors: Alysson Renato BENTO, Piracicaba (BR); João Augusto Marcolin LUCCA, São Pedro (BR); Igor Alexander SPRENGEL, Manheim, Banden Würtemberg (DE)

(21) Appl. No.: 18/265,182

(22) PCT Filed: Nov. 26, 2021
(86) PCT No.: PCT/BR2021/050522

§ 371 Date: Jun. 2, 2023

(30) Foreign Application Priority Data
Dec. 3, 2020 (BR) 102020024754-9

(51) Int. Cl. A01D 41/14; A01B 63/00; A01D 45/10

(52) U.S. Cl. CPC A01D 41/141; A01B 63/008; A01D 45/10

(57) ABSTRACT

A system for automatic topper control for an agricultural harvester includes a topper assembly having a cutting disk, and a rotational drive source configured to rotationally drive the cutting disk. The system also includes an actuator for adjusting a cutting height of the cutting disk. In addition, the system includes a controller configured to monitor a drive-related pressure parameter associated with an operation of the rotational drive source of the topper assembly. The controller is further configured to control an operation of the actuator to adjust the cutting height of the cutting disk based at least in part on the monitored drive-related parameter.

### FIELD OF THE INVENTION

The present subject matter relates generally to topper assemblies for agricultural harvesters, such as sugarcane harvesters, and, more particularly, to systems and methods for automatically controlling the operation of a topper assembly of an agricultural harvester.

### BACKGROUND OF THE INVENTION

A sugarcane harvester typically includes a topper assembly positioned at its front end for intercepting sugarcane as the harvester is moved in the forward direction across a field. The topper assembly typically includes a cutting disk configured to sever the leafy tops of the sugarcane for disposal along either side of harvester. For example, ready-to-harvest sugarcane is generally characterized by a leafy top including green leaves and a millable stalk underneath the leafy top. In this regard, it is generally desirable to use the topper assembly to cut-off the leafy top right above the stalk without removing any of the stalk, itself, and without leaving a substantial amount of leaves (which would increase the amount of trash intake into the harvester).

Currently, operators are required to manually adjust the height of the topper assembly as the harvester is moved across the field to account for variations in the height of the sugarcane being harvested. However, such height adjustments require a significant amount of the operator's time and attention. Unfortunately, since the operator must also focus his/her attention on various other manually adjusted parameters, such as the height of the base cutter assembly, row alignment of the harvester, elevator-related parameters, vehicle speed, etc., the topper assembly is often set at a given height by the operator and maintained at such height throughout the entire harvesting operation. As a result, the cutting height associated with the cutting disk is often too high or too low relative to the sugarcane being harvested, which results in either a significant amount of leafy trash intake into the harvester (e.g., if the cutting height is too high) or a portion of the millable stalk being cut-off (e.g., if the cutting height is too low), both of which are undesirable.

Accordingly, a system and method for automatically controlling the operation of a topper assembly of an agricultural harvester would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for automatic topper control for an agricultural harvester. The system includes a topper assembly having a cutting disk and a rotational drive source configured to rotationally drive the cutting disk. The system also includes an actuator for adjusting a cutting height of the cutting disk. In addition, the system includes a controller configured to monitor a drive-related parameter associated with an operation of the rotational drive source of the topper assembly. The controller is further configured to control an operation of the actuator to adjust the cutting height of the cutting disk based at least in part on the monitored drive-related parameter.

In another aspect, the present subject matter is directed to an agricultural harvester including a frame, a topper arm supported relative to a front end of the frame, and a hydraulic motor coupled to the topper arm, with the hydraulic motor being fluidly coupled to a hydraulic circuit for suppling hydraulic fluid to the hydraulic motor. The harvester also includes a cutting disk coupled to the hydraulic motor such that the hydraulic motor is configured to rotationally drive the cutting disk, and an actuator coupled between the topper arm and the frame, with the actuator being configured to actuate the topper arm relative to the frame for adjusting a cutting height of the cutting disk. In addition, the harvester includes a pressure sensor configured to detect a pressure parameter associated with a fluid pressure of the hydraulic fluid directed through the hydraulic circuit, and a controller communicatively coupled to the pressure sensor that is configured to monitor the pressure parameter based on feedback received from the pressure sensor. The controller is further configured to control an operation of the actuator to adjust the cutting height of the cutting disk based at least in part on the monitored pressure parameter.

In a further aspect, the present subject matter is directed to a method for automatic topper control for an agricultural harvester, with the harvester including a topper assembly having a cutting disk and a rotational drive source coupled to the cutting disk. The method includes controlling an operation of the rotational drive source such that the rotational drive source rotationally drives the cutting disk, and monitoring, with a computing device, a drive-related parameter associated with the operation of the rotational drive source. In addition, the method includes adjusting, with the computing device, a cutting height of the cutting disk based at least in part on the monitored drive-related parameter.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of one embodiment of an agricultural harvester in accordance with aspects of the present subject matter;

FIG. 2 illustrates a schematic view of one embodiment of a system for automatic topper control for an agricultural harvester in accordance with aspects of the present subject matter; and

FIG. 3 illustrates a flow diagram of one embodiment of a method for automatic topper control for an agricultural harvester in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for automatic topper control for an agricultural harvester. Specifically, in several embodiments, the disclosed systems and methods allow for the cutting height of a topper assembly of a sugarcane harvester to be automatically adjusted so as to maintain the cutting disk(s) of the topper assembly at a desired vertical position relative to the sugarcane being harvested. For instance, a controller may be communicatively coupled to one or more sensors configured to detect a drive-related parameter associated with the operation of a rotational drive source of the topper assembly, with the drive-related parameter being generally indicative of the vertical position of the cutting disk(s) relative to the sugarcane. In such embodiments, the controller may be configured to monitor the drive-related parameter relative to one or more predetermined thresholds and automatically adjust the cutting height of the cutting disk(s) when the monitored parameter differs from the predetermined threshold(s) so as to maintain the cutting disk(s) at the desired vertical position relative to the tops of the sugarcane being harvested. As will be described below, the drive-related parameter may generally correspond to a parameter associated with the power or driving force required for the rotational drive source to rotationally drive the cutting disk(s) of the topper assembly. For example, when the cutting disk(s) is configured to be rotationally driven via a hydraulic motor, the drive-related parameter may correspond to a pressure-related parameter associated with a fluid pressure(s) of the hydraulic fluid being supplied to the hydraulic motor.

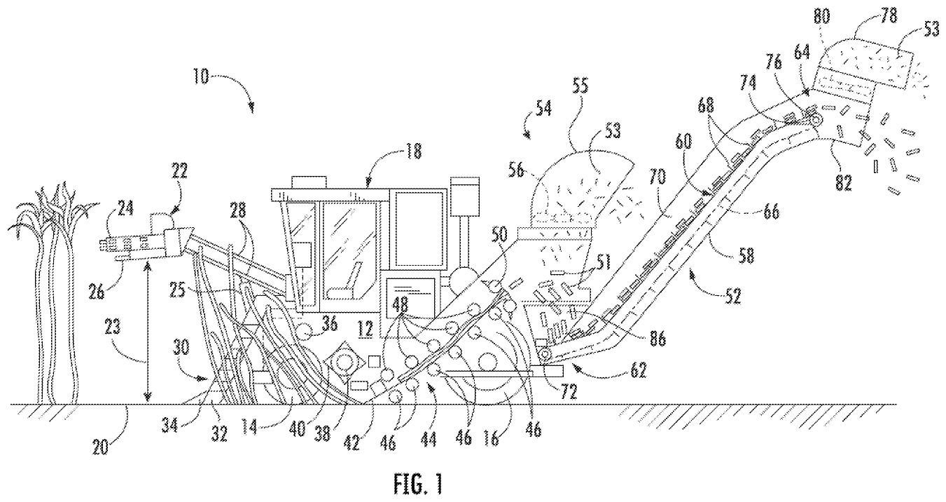

Referring now to the drawings, FIG. 1 illustrates a side view of one embodiment of a sugarcane harvester 10 in accordance with aspects of the present subject matter. As shown in FIG. 1, the harvester 10 includes a frame 12, a pair of front wheels 14, a pair of rear wheels 16, and an operator's cab 18. The harvester 10 also includes a primary source of power (e.g., an engine mounted on the frame 12) which powers one or both pairs of the wheels 14, 16 via a transmission (not shown). Alternatively, the harvester 10 may be a track-driven harvester and, thus, may include tracks driven by the engine as opposed to the illustrated wheels 14, 16. The engine may also drive a hydraulic fluid pump (not shown) configured to generate pressurized hydraulic fluid for powering various hydraulic components of the harvester 10.

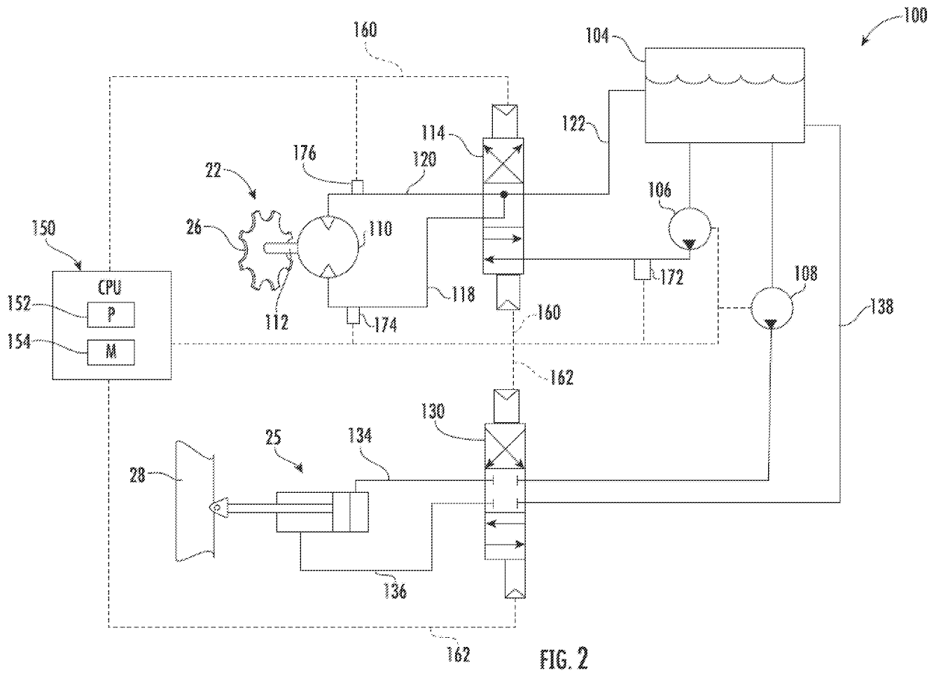

Additionally, the harvester 10 includes various components for cutting/harvesting, processing, cleaning, and discharging sugarcane as the cane is harvested from an agricultural field 20. For instance, the harvester 10 includes a topper assembly 22 positioned at its front end to intercept sugarcane as the harvester 10 is moved in the forward direction. As shown, the topper assembly 22 includes one or more gathering disks 24 and one or more cutting disks 26. The gathering disk(s) 24 may be configured to gather the sugarcane stalks so that the cutting disk(s) 26 may be used to cut off the leafy top of each plant. In accordance with aspects of the present subject matter, a cutting height 23 of the topper assembly 22 relative to the field 20 may be automatically adjustable to maintain the cutting disk(s) 26 at a desired vertical position relative to the sugarcane being harvested. For instance, as will be described below with reference to FIG. 2, a suitable control device or controller may be configured to monitor a drive-related parameter of the topper assembly 22 that is generally indicative of the vertical position of the cutting disk(s) 26 relative to the sugarcane being harvested and automatically adjust the height 23, if necessary, based on the monitored parameter. Specifically, in several embodiments, the controller may be configured to automatically raise/lower one or more topper arms 28 that support the gathering disk(s) 24 and cutting disk(s) 26 in a cantilevered arrangement relative to the field 20 by controlling the operation of an associated topper actuator(s) 25 coupled between the topper arm(s) 28 and the frame 12 of the harvester 10.

Additionally, the harvester 10 includes a crop divider 30 that extends upwardly and rearwardly from the field 20. In general, the crop divider 30 may include two spiral feed rollers 32. Each feed roller 32 includes a ground shoe 34 at its lower end to assist the crop divider 30 in gathering the sugarcane stalks for harvesting. Moreover, as shown in FIG. 1, the harvester 10 includes a knock-down roller 36 positioned near the front wheels 14 and a fin roller 38 positioned behind the knock-down roller 36. As the knock-down roller 36 is rotated, the sugarcane stalks being harvested are knocked down while the crop divider 30 gathers the stalks from agricultural field 20. Further, as shown in FIG. 1, the fin roller 38 includes a plurality of intermittently mounted fins 40 that assist in forcing the sugarcane stalks downwardly. As the fin roller 38 is rotated during the harvest, the sugarcane stalks that have been knocked down by the knock-down roller 36 are separated and further knocked down by the fin roller 38 as the harvester 10 continues to be moved in the forward direction relative to the field 20.

Referring still to FIG. 1, the harvester 10 also includes a base cutter assembly 42 mounted on the frame 12 behind the fin roller 38. As is generally understood, the base cutter assembly 42 includes blades (not shown) for severing the sugarcane stalks as the cane is being harvested. The blades, located on the periphery of the assembly 42, may be rotated by a hydraulic motor (not shown) powered by the vehicle's hydraulic system. As indicated above, the base cutter assembly 42 is generally provided in a fixed positional relationship with the frame 12, thereby requiring the entire machine to be raised and lowered to adjust the vertical positioning of the assembly 42 when encountering variations in the ground contour.

Moreover, the harvester 10 includes a feed roller assembly 44 located downstream of the base cutter assembly 42 for moving the severed stalks of sugarcane from base cutter assembly 42 along the processing path. As shown in FIG. 1, the feed roller assembly 44 includes a plurality of bottom rollers 46 and a plurality of opposed, top pinch rollers 48. The various bottom and top rollers 46, 48 are generally used to pinch the harvested sugarcane during transport. As the sugarcane is transported through the feed roller assembly 44, debris (e.g., rocks, dirt, and/or the like) is allowed to fall through bottom rollers 46 onto the field 20.

In addition, the harvester 10 includes a chopper assembly 50 located at the downstream end of the feed roller assembly 44 (e.g., adjacent to the rearward-most bottom and top feed rollers 46, 48). In general, the chopper assembly 50 is used to cut or chop the severed sugarcane stalks into pieces or “billets” 51, which may be, for example, six (6) inches long. The billets 51 may then be propelled towards an elevator assembly 52 of the harvester 10 for delivery to an external receiver or storage device (not shown).

As is generally understood, pieces of debris 53 (e.g., dust, dirt, leaves, etc.) separated from the sugarcane billets 51 are expelled from the harvester 10 through a primary extractor 54, which is located immediately behind the chopper assembly 50 and is oriented to direct the debris 53 outwardly from the harvester 10. The primary extractor 54 may include, for example, an extractor hood 55 and an extractor fan 56 mounted within the hood 55 for generating a suction force or vacuum sufficient to pick up the debris 53 and force the debris 53 through the hood 55. The separated or cleaned billets 51, heavier than the debris 53 being expelled through the extractor 54, may then fall downward to the elevator assembly 52.

As shown in FIG. 1, the elevator assembly 52 generally includes an elevator housing 58 and an elevator 60 extending within the elevator housing 58 between a lower, proximal end 62 and an upper, distal end 64. In general, the elevator 60 includes a looped chain 66 and a plurality of flights or paddles 68 attached to and evenly spaced on the chain 66. The paddles 68 are configured to hold the sugarcane billets 51 on the elevator 60 as the billets are elevated along a top span 70 of the elevator 70 defines between its proximal and distal ends 62, 64. Additionally, the elevator 60 includes lower and upper sprockets 72, 74 positioned at its proximal and distal ends 62, 64, respectively. As shown in FIG. 1, an elevator motor 76 is coupled to one of the sprockets (e.g., the upper sprocket 74) for driving the chain 66, thereby allowing the chain 66 and the paddles 68 to travel in an endless loop between the proximal and distal ends 62, 64 of the elevator 60.

Moreover, in some embodiments, pieces of debris 53 (e.g., dust, dirt, leaves, etc.) separated from the elevated sugarcane billets 51 may be expelled from the harvester 10 through a secondary extractor 78 coupled to the rear end of the elevator housing 58. For example, the debris 53 expelled by the secondary extractor 78 may be debris remaining after the billets 51 are cleaned and debris 53 expelled by the primary extractor 54. As shown in FIG. 1, the secondary extractor 78 is located adjacent to the distal end 64 of the elevator 60 and may be oriented to direct the debris 53 outwardly from the harvester 10. Additionally, an extractor fan 80 is mounted at the base of the secondary extractor 78 for generating a suction force or vacuum sufficient to pick up the debris 53 and force the debris 53 through the secondary extractor 78. The separated, cleaned billets 51, heavier than the debris 53 expelled through the extractor 78, may then fall from the distal end 64 of the elevator 60. Typically, the billets 51 may fall downwardly through an elevator discharge opening 82 of the elevator assembly 52 into an external storage device (not shown), such as a sugarcane billet cart.

During operation, the harvester 10 is traversed across the agricultural field 20 for harvesting sugarcane. The gathering disk 24 on the topper assembly 22 functions to gather the sugarcane stalks as the harvester 10 proceeds across the field 20, while the cutter disk 26 severs the leafy tops of the sugarcane for disposal along either side of harvester 10. As the stalks enter the crop divider 30, the spiral feed rollers 32 gather the stalks into the throat to allow the knock-down roller 36 to bend the stalks downwardly in conjunction with the action of the fin roller 38. Once the stalks are angled downwardly as shown in FIG. 1, the base cutter assembly 42 severs the base of the stalks from field 20. The severed stalks are then, by movement of the harvester 10, directed to the feed roller assembly 44.

The severed sugarcane stalks are conveyed rearwardly by the bottom and top feed rollers 46, 48, which compress the stalks, make them more uniform, and shake loose debris to pass through the bottom rollers 46 to the field 20. At the downstream end of the feed roller assembly 44, the chopper assembly 50 cuts or chops the compressed sugarcane stalks into pieces or billets 51 (e.g., 6 inch cane sections). The processed crop material discharged from the chopper assembly 50 is then directed as a stream of billets 51 and debris 53 into the primary extractor 54. The airborne debris 53 (e.g., dust, dirt, leaves, etc.) separated from the sugarcane billets is then extracted through the primary extractor 54 using suction created by the extractor fan 56. The separated/cleaned billets 51 then fall downwardly through an elevator hopper 86 into the elevator assembly 52 and travel upwardly via the elevator 60 from its proximal end 62 to its distal end 64. During normal operation, once the billets 51 reach the distal end 64 of the elevator 60, the billets 51 fall through the elevator discharge opening 82 to an external storage device. If provided, the secondary extractor 78 (with the aid of the extractor fan 80) blows out trash/debris 53 from harvester 10, similar to the primary extractor 54.

Referring now to FIG. 2, a schematic view of one embodiment of a system 100 for automatic topper control for an agricultural harvester is illustrated in accordance with aspects of the present subject matter. For purposes of discussion, the system 100 will generally be described herein with reference to the agricultural harvester 10 described above with reference to FIG. 1. However, it be appreciated that, in general, the system 100 may be utilized with agricultural harvesters having any other suitable harvester configuration to allow for automatic control of the harvester's topper assembly.

As shown in FIG. 2, the system 100 includes a hydraulic circuit 102 forming one or more hydraulic flow loops (e.g., an open flow loop(s) due to the fluid being returned to and supplied from a holding tank 104) through which a hydraulic fluid (e.g., oil) is pumped via operation of one or more associated circuit pumps (e.g., a first pump 106 and a second pump 108). In general, the hydraulic circuit 102 may be configured for supplying pressurized hydraulic fluid to one or more corresponding hydraulic components of the harvester 10. For instance, as shown in FIG. 2, the topper assembly 22 may include one or more hydraulic motors 110 (e.g., one or more bidirectional motor(s)) for rotationally driving the cutting disk(s) 26 of the topper assembly 22 (e.g., via an output shaft(s) 112 of the motor(s) 110), such as by including a respective hydraulic motor 110 for rotationally driving each respective cutting disk 26 of the topper assembly 22. Additionally, as indicated above, the harvester 10 may include a topper actuator 25 (e.g., a hydraulic cylinder) for raising and lowering the topper assembly 22 relative to the field (and, more particularly, relative to the tops of the sugarcane to be harvested). In such an embodiment, hydraulic fluid may be directed through the hydraulic circuit 100 for supply to both the hydraulic motor(s) 110 for rotationally driving the cutting disk(s) 26 and the topper actuator 25 for adjusting the cutting height of the cutting disk(s) 26.

As shown in FIG. 2, the hydraulic circuit 102 includes a topper control valve 114 (e.g., a solenoid activated valve) positioned downstream of the first pump 106 for regulating the supply of hydraulic fluid to the hydraulic motor(s) 110. For instance, the first pump 106 may be configured to pump hydraulic fluid through a first pump supply line 116 to the control valve 114, at which point the control valve 114 may regulate the flow of hydraulic fluid to the hydraulic motor(s) 110 through either a first motor line 118 or a second motor line 120 depending on the rotational direction of the hydraulic motor(s) 110. Specifically, when the hydraulic motor(s) 110 is being rotated in a first direction, the first motor line 118 may serves as the supply line from the control valve 114 to the hydraulic motor(s) 110 and the second motor line 120 may serve as the return line from the motor(s) 110 back to the valve 114. In contrast, when the hydraulic motor(s) is being rotated in the opposite direction, the second motor line 120 may serve as the supply line and the first motor line 118 may serve as the return line. The return fluid directed back to the valve 114 may then be returned to the holding tank 104 via an associated tank return line 122.

It should be appreciated that, as an alternative to providing a hydraulic drive arrangement for rotationally driving the cutting disk(s) 26, any other suitable drive arrangement may be utilized for rotationally driving the cutting disk(s) 26. For instance, as opposed to the hydraulic circuit 102 and associated hydraulic motor(s) 110, the cutting disk(s) 26 may be rotationally driven using any other suitable drive source, such as an electrical motor, pneumatic-based rotational drive source, and/or a mechanical-based drive source.

Additionally, as shown in FIG. 2, the hydraulic circuit 102 also includes an actuator control valve 130 (e.g., a solenoid activated valve) positioned downstream of the second pump 108 for regulating the supply of hydraulic fluid to the topper actuator 25. For instance, the pump 108 may be configured to pump hydraulic fluid through a second pump supply line 132 to the control valve 130, at which point the control valve 130 may regulate the flow of hydraulic fluid to a cap-side chamber of the topper actuator 25 (e.g., via a first actuator line 134) and/or a rod-side chamber of the topper actuator 25 (via a second actuator line 136) to regulate the extension/retraction of the actuator 25 and, thus, vary the cutting height 23 of the cutting disk(s) 26 by pivoting the topper arm(s) 28 upwards or downwards. Return fluid directed back to the valve 130 may be returned to the holding tank 104 via an associated tank return line 138.

Referring still to FIG. 2, the system 100 also includes a controller 150 for electronically controlling the operation of one more of the system components. For example, as will be described below, the controller 150 may, in several embodiments, be communicatively coupled to one or more sensors configured to detect a drive-related parameter associated with the rotational drive source for the topper assembly 22, with the drive-related parameter being generally indicative of the vertical position of the cutting disk(s) 26 relative to the sugarcane being harvested. In such embodiments, the controller 150 may be configured to monitor the drive-related parameter relative to one or more predetermined thresholds and automatically adjust the cutting height 23 of the cutting disk(s) 26 when the monitored parameter differs from the predetermined threshold(s) so as to maintain the cutting disk(s) at the desired vertical position relative to the tops of the sugarcane being harvested.

In general, the controller 150 may correspond to any suitable processor-based device(s), such as a computing device or any combination of computing devices. Thus, in several embodiments, the controller 150 may include one or more processor(s) 152 and associated memory device(s) 154 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 154 of the controller 150 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD) and/or other suitable memory elements. Such memory device(s) 154 may generally be configured to store suitable computer-readable instructions that, when implemented by the processor(s) 152, configure the controller 150 to perform various computer-implemented functions, such as the processing and/or control functionality described herein.

It should be appreciated that the controller 150 may be configured to interface with and/or be incorporated into existing hardware and/or software of the harvester 10. In other words, the controller 150 may be configured as a separate unit forming part of the disclosed system 100 and/or may be integrated with the harvester 10. For instance, the harvester 10 may have a dedicated harvester controller which controls specific harvester-related functions, and the controller 150 may either be in the form of the dedicated harvester controller or be incorporated as part of the dedicated harvester controller.

In several embodiments, the controller 150 may be configured to electronically control the operation of the topper control valve 114 and/or the actuator control valve 130. For instance, as shown in FIG. 2, the controller 150 may be communicatively coupled to the topper control valve 114 (e.g., via communicative link 160) to allow the controller 150 to electronically control the operation of the valve 114. In such an embodiment, by controlling the operation of the topper control valve 114, the controller 150 may, in turn, regulate the rotational speed and/or rotational direction of the hydraulic motor(s) 110. Similarly, as shown in FIG. 2, the controller 150 may be communicatively coupled to the actuator control valve 130 (e.g., via communicative link 162) to allow the controller 150 to electronically control the operation of the valve 130. In such an embodiment, by controlling the operation of the actuator control valve 130, the controller 150 may, in turn, regulate the extension/retraction of the associated actuator 25 and, thus, the cutting height 23 of the cutting disk(s) 26.

As indicated above, in several embodiments, the controller 150 may be configured to monitor a drive-related parameter associated with the operation of the rotational drive source for the topper assembly 22, with the drive-related parameter being generally indicative of the vertical position of the cutting disk(s) 26 relative to the sugarcane being harvested. In general, the drive-related parameter may correspond to a parameter associated with the power or driving force required for the rotational drive source to rotationally drive the cutting disk(s) 26 of the topper assembly 22. For example, in several embodiments, the drive-related parameter monitored by the controller 150 may correspond to a pressure-related parameter (hereinafter referred to as the “pressure parameter) associated with the pressure of the hydraulic fluid being circulated through a motor-related portion 170 of the hydraulic circuit 102 (e.g., the flow path defined by the pump line 116, motor lines 118, 120, and return line 122 that extends through the control valve 114 and the motor(s) 110). As will be described below, the pressure parameter may, for example, correspond to a sensed pressure of the hydraulic fluid at a given location within the motor-related portion 170 of the hydraulic circuit 102 or a pressure differential between two separate fluid pressures sensed at different locations within the motor-related portion 170 of the hydraulic circuit 102. Alternatively, in embodiments in which the cutting disk(s) 26 is configured to be rotationally driven via a non-hydraulic-based rotational drive source, the drive-related parameter may correspond to any other suitable parameter associated with the required power or driving force for rotationally driving the cutting disk(s) 26. For instance, if the cutting disk(s) 26 is configured to be rotationally driven by an electric motor, the drive-related parameter may correspond to the current supplied to the motor. Alternatively, if the cutting disk(s) 26 is configured to be rotationally driven via a mechanical-based rotational drive source, the drive-related parameter may correspond to the drive torque transmitted via the drive arrangement. In yet another embodiment, if the cutting disk(s) 26 is configured to be rotationally driven via a pneumatics-based rotational drive source, the drive-related parameter may correspond to the pressure of the air being supplied to such drive source.

Regardless of the type of drive arrangement being utilized for rotationally driving the cutting disk(s) 26, the monitored drive-related parameter will generally be indicative of the vertical position of the cutting disk(s) 26 relative to the sugarcane being harvested. Specifically, the required power or driving force for rotationally driving the cutting disk(s) 26 will generally vary depending on the relative vertical location at which the sugarcane is being cut by the cutting disk(s) 26. As such, by monitoring a parameter(s) associated with the required power or driving force for rotationally driving the cutting disk(s) 26, the controller 150 may determine or infer the vertical position of the cutting disk(s) 26 relative to the sugarcane being harvested.

For example, in the illustrated embodiment, the fluid pressure (or pressure differential) within the motor-related portion of the hydraulic circuit 102 will generally vary depending on the relative vertical location at which the sugarcane is being cut by the cutting disk(s) 26. For example, as indicated above, ready-to-harvest sugarcane is generally characterized by a leafy top including green leaves and a millable stalk underneath the leafy top, and it is generally desirable to cut-off the leafy top right above the stalk without removing any of the stalk, itself, and without leaving a substantial amount of leaves (which would increase the amount of trash intake into the harvester). In this regard, the pressure within the motor-related portion 170 of the hydraulic circuit 102 will generally be higher if the cutting disk(s) 26 is positioned too low (and, thus, is cutting into the millable stalk) and will generally be lower if the cutting disk(s) 26 is positioned too high (and, thus, is cutting through only a portion of the leafy top or is not cutting though anything because the disk(s) 26 is positioned above the leafy top). Accordingly, in several embodiments, a predetermined pressure range (or pressure differential range) may be established that defines the pressure values (or pressure differential values) corresponding to the desired cutting location for the cutting disk(s) 26 relative to the sugarcane. For example, a maximum pressure threshold (or maximum differential threshold) may be established for the predetermined range that corresponds to the average fluid pressure (or average pressure differential) within the motor-related portion 170 of the hydraulic circuit 102 when the cutting disk(s) 26 is positioned immediately above the millable stalk and a minimum pressure threshold (or minimum differential threshold) may be established for the predetermined range that corresponds to the average fluid pressure (or average pressure differential) within the motor-related portion 170 of the hydraulic circuit 102 when the cutting disk(s) 26 is positioned above the millable stalk by some acceptable distance (e.g., 2-6 inches). In such an embodiment, by monitoring the pressure parameter relative to the associated pressure-related range, the controller 150 may be configured to determine when the cutting disk(s) 26 is located too high (e.g., due to the monitored pressure parameter falling below the minimum threshold for the range) or too low (e.g., due to the monitored pressure parameter exceeding the maximum threshold for the range) relative to the sugarcane being harvested and make adjustments, as necessary, to ensure that the cutting disk(s) 26 is maintained at the desired vertical position relative to the tops of the sugarcane.

As indicated above, in one embodiment, the pressure parameter monitored by the controller 150 may correspond to a sensed pressure(s) of the hydraulic fluid within the motor-related portion 170 of the hydraulic circuit 102. In such an embodiment, one or more pressure sensors may be provided in fluid communication with the motor-related portion 170 of the hydraulic circuit 102 at a suitable location(s) for detecting such pressure(s). For instance, as shown in FIG. 2, in one embodiment, a pressure sensor 172 may be provided in fluid communication with the first pump supply line 116 to allow the fluid pressure to be monitored upstream of the motor control valve 114. In such an embodiment, the controller 150 may, for example, be configured to monitor the fluid pressure within the motor-related portion 170 of the hydraulic circuit 102 and compare such monitored pressure to a predetermined pressure range associated with the cutting disk(s) 26 being at the desired vertical position relative to the sugarcane being harvested. If the monitored pressured exceeds or falls below the predetermined pressure range, the controller 150 may then adjust the cutting height 23 of the cutting disk(s) 26 (either up or down, as appropriate) to ensure that the cutting disk(s) 26 is properly located relative to the tops of the sugarcane.

Alternatively, as indicated above, the pressure parameter monitored by the controller 150 may, instead, correspond to a pressure differential within the motor-related portion 170 of the hydraulic circuit 102. In such an embodiment, a pair of pressure sensors may be provided fluid communication with the motor-related portion 170 of the hydraulic circuit 102 at suitable locations for detecting such pressure differential. For instance, as shown in FIG. 2, in one embodiment, first and second pressure sensors 174, 176 may be provided in fluid communication with the first and second motor lines 118, 120, respectively, to allow the fluid pressure within such lines 118, 120 to be monitored. Thus, depending on the direction of flow through the hydraulic motor(s) 110, one of the pressure sensors will be positioned upstream of the hydraulic motor(s) 110 and the other pressure sensor will be positioned downstream of the hydraulic motor(s) 110. In such an embodiment, the controller 150 may, for example, be configured to determine the pressure differential across the hydraulic motor(s) 110 based on the monitored fluid pressures and compare such pressure differential to a predetermined pressure differential range associated with the cutting disk(s) 26 being at the desired vertical position relative to the sugarcane being harvested. If the pressured differential exceeds or falls below the predetermined pressure differential range, the controller 150 may then adjust the cutting height 23 of the cutting disk(s) 26 (either up or down, as appropriate) to ensure that the cutting disk(s) 26 is properly located relative to the tops of the sugarcane.

It should be appreciated that, in embodiments in which the drive-related parameter corresponds to a parameter other than the pressure parameter associated with the pressure of the hydraulic fluid being circulated through a motor-related portion 170 of the hydraulic circuit 102, a similar threshold or range-based analysis may be executed by the controller 150 to determine whether the cutting disk(s) 26 is at the desired vertical position relative to the sugarcane being harvested. For instance, when the monitored drive-related parameter corresponds to an electrical current supplied to an electric motor configured to rotationally drive the cutting disk(s), the controller 150 may, for example, be configured to monitor the current supplied to the motor and compare such monitored current to a predetermined current range associated with the cutting disk(s) 26 being at the desired vertical position relative to the sugarcane being harvested. If the monitored current exceeds or falls below the predetermined current range, the controller 150 may then adjust the cutting height 23 of the cutting disk(s) 26 (either up or down, as appropriate) to ensure that the cutting disk(s) 26 is properly located relative to the tops of the sugarcane. A similar analysis may also be utilized for a pneumatic-based and/or mechanical-based rotational drive source, such as by comparing the monitored drive-related parameter to a corresponding air pressure range and/or torque range associated with the cutting disk(s) 26 being at the desired vertical position relative to the sugarcane being harvested.

As indicated above, the controller 150 may be configured to automatically adjust the cutting height 23 of the cutting disk(s) 26 by electronically controlling the operation of the actuator control valve 130 to regulate the extension/retraction of the topper actuator 25. Accordingly, by monitoring the drive-related parameter relative to the associated predetermined range), the controller 150 may determine when the cutting height 23 needs to be adjusted and subsequently adjust such height 23 by controlling the actuator control valve 130. As such, the cutting disk(s) 26 may be maintained at the desired vertical position relative to the tops of the sugarcane being harvested as the harvester 10 is being moved across the field during the performance of a harvesting operation.

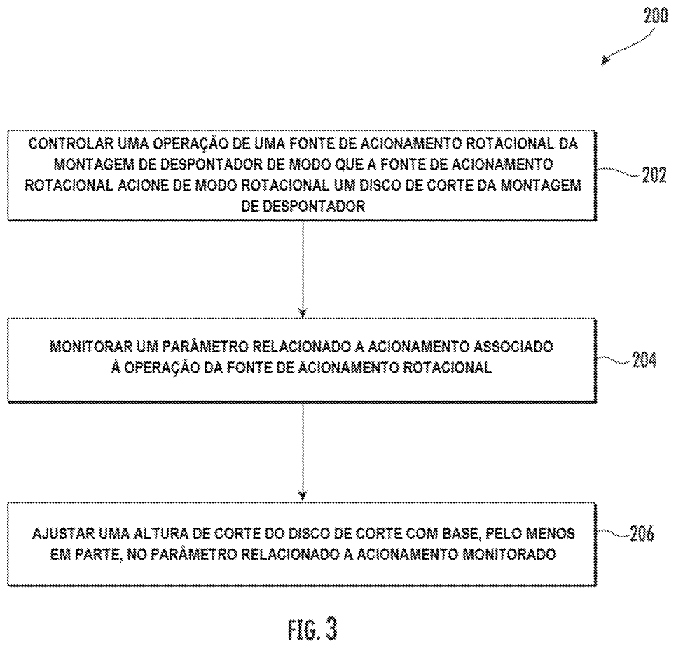

Referring now to FIG. 3, a flow diagram of one embodiment of a method 200 for automatic topper control for an agricultural harvester is illustrated in accordance with aspects of the present subject matter. For purposes of discussion, the method 200 will generally be described herein with reference to the harvester 10 and the system 100 described above with reference to FIGS. 1 and 2. However, it should be appreciated that the disclosed method 200 may generally be executed in association with any harvester have any other suitable harvester configuration and/or any system having any other suitable system configuration. Additionally, although FIG. 3 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 3, at (202) the method 200 may include controlling an operation of a rotational drive source of a topper assembly to rotational drive a cutting disk of the topper assembly. In several embodiments, the rotational drive source may correspond to a hydraulic motor, in which case the supply of hydraulic fluid directed to the hydraulic motor may be controlled such that the hydraulic motor rotationally drives the cutting disk. For instance, as indicated above, the controller 150 may be configured to control the operation of the topper control valve 114 to regulate or control the supply of hydraulic fluid directed to the hydraulic motor(s) 110 of the topper assembly 22. In other embodiments, the controller 150 may be configured to control the operation of any other suitable rotational drive source configured to rotationally drive the cutting disk(s) 26, such as an electric motor, a pneumatic-based rotational drive source, and/or a mechanical-based rotational drive source.

Additionally, at (204), the method 200 may include monitoring a drive-related parameter associated with the operation of the rotational drive source. Specifically, as indicated above, the controller 150 may, in several embodiments, be communicatively coupled to one or more pressure sensors for monitoring a pressure parameter associated with the hydraulic fluid within the hydraulic circuit 102. For instance, in one embodiment, the controller 150 may be configured to monitor the pressure(s) of the hydraulic fluid at one or more locations within the hydraulic circuit 102, such as the pressure of the hydraulic fluid supply between the first pump 106 and the topper control valve 114 (e.g., via pressure sensor 172). Alternatively, the controller 150 may be configured to monitor a pressure differential across two or more locations within the hydraulic circuit 102, such as the pressure differential across the hydraulic motor(s) 110 (e.g., via the first and second pressure sensor 174, 176). In further embodiments, the controller 150 may be communicatively coupled to any other suitable sensors that allow the controller 150 to monitor the drive-related parameter.

Moreover, at (206), the method 200 may include adjusting a cutting height of the cutting disk based at least in part on the monitored drive-related parameter. Specifically, as indicated above, the controller 150 may, in several embodiments, be configured to monitor the drive-related parameter relative to one or more thresholds, such as maximum and minimum thresholds associated with a predetermined range established for the drive-related parameter. In such embodiments, when the monitored drive-related parameter falls outside the predetermined range, the controller 150 may be configured to adjust the cutting height 23 of the cutting disk(s) 26 by controlling the operation of the associated actuator control valve 130, thereby allowing the controller 150 to regulate the extension/retraction of the topper actuator 25 and, thus, the vertical position of the cutting disk(s) 26.

It is to be understood that one or more of the steps of the method 200 are performed by a computing device(s) (e.g., controller 150) upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing device(s) described herein, such as the method 200, is implemented in software code or instructions which are tangibly stored on a tangible computer readable medium. The computing device(s) loads the software code or instructions via a direct interface with the computer readable medium or via a wired and/or wireless network. Upon loading and executing such software code or instructions by the computing device(s), the computing device(s) may perform any of the functionality of the computing device(s) described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A system for automatic topper control for an agricultural harvester, the system comprising:
a topper assembly comprising a cutting disk and a rotational drive source configured to rotationally drive the cutting disk;
an actuator for adjusting a cutting height of the cutting disk; and
a controller configured to monitor a drive-related parameter associated with an operation of the rotational drive source of the topper assembly, the controller being further configured to control an operation of the actuator to adjust the cutting height of the cutting disk based at least in part on the monitored drive-related parameter.

2. The system of claim 1, wherein the controller is configured to compare the drive-related parameter to at least one predetermined threshold associated with the drive-related parameter, the controller being configured to control the operation of the actuator to adjust the cutting height of the cutting disk when the drive-related parameter differs from the at least one predetermined threshold.

3. The system of claim 2, wherein the at least one predetermined threshold comprises a maximum threshold and a minimum threshold of a predetermined range associated with the drive-related parameter, the controller being configured to control the operation of the actuator to adjust the cutting height of the cutting disk when the drive-related parameter falls outside the predetermined range.

4. The system of claim 1, wherein the rotational drive source comprises a hydraulic motor fluidly coupled to a hydraulic circuit for supplying hydraulic fluid to the hydraulic motor and wherein the drive-related parameter comprises a pressure parameter associated with a fluid pressure of the hydraulic fluid directed through the hydraulic circuit, the system further comprising a pressure sensor configured to detect the pressure parameter, the controller being communicatively coupled to the pressure sensor such that the controller is configured to monitor the pressure parameter based on feedback received from the pressure sensor.

5. The system of claim 4, wherein the pressure sensor comprises a first pressure sensor configured to detect an upstream pressure of the hydraulic fluid at a location upstream of the hydraulic motor and further comprising a second pressure sensor configured to detect a downstream pressure of the hydraulic fluid at a location downstream of the hydraulic motor, wherein the monitored pressure parameter comprises a pressure differential between the upstream and downstream pressures.

6. The system of claim 4, wherein the pressure parameter comprises a sensed pressure of the hydraulic fluid at a given location within the hydraulic circuit.

7. The system of claim 6, further comprising a control valve configured to regulate a flow of the hydraulic fluid to the hydraulic motor and a pump configured to supply the hydraulic fluid to the control valve, the pressure sensor being fluidly coupled to the hydraulic circuit downstream of the pump and upstream of the control valve such that the monitored pressure parameter comprises the sensed pressure of the hydraulic fluid flowing between the pump and the control valve.

8. The system of claim 1, wherein the controller is configured to control the operation of the actuator based on the monitored drive-related parameter so as to maintain the cutting disk at a desired vertical position relative to crops to be harvested.

9. An agricultural harvester, comprising:
a frame;
a topper arm supported relative to a front end of the frame;
a hydraulic motor coupled to the topper arm, the hydraulic motor being fluidly coupled to a hydraulic circuit for suppling hydraulic fluid to the hydraulic motor;
a cutting disk coupled to the hydraulic motor such that the hydraulic motor is configured to rotationally drive the cutting disk;
an actuator coupled between the topper arm and the frame, the actuator being configured to actuate the topper arm relative to the frame for adjusting a cutting height of the cutting disk;
a pressure sensor configured to detect a pressure parameter associated with a fluid pressure of the hydraulic fluid directed through the hydraulic circuit; and
a controller communicatively coupled to the pressure sensor and being configured to monitor the pressure parameter based on feedback received from the pressure sensor, the controller being further configured to control an operation of the actuator to adjust the cutting height of the cutting disk based at least in part on the monitored pressure parameter.

10. The agricultural harvester of claim 9, wherein the controller is configured to compare the pressure parameter to at least one predetermined threshold associated with the pressure parameter, the controller being configured to control the operation of the actuator to adjust the cutting height of the cutting disk when the pressure parameter differs from the at least one predetermined threshold.

11. The agricultural harvester of claim 10, wherein the at least one predetermined threshold comprises a maximum threshold and a minimum threshold of a predetermined range associated with the pressure parameter, the controller being configured to control the operation of the actuator to adjust the cutting height of the cutting disk when the pressure parameter falls outside the predetermined range.

12. The agricultural harvester of claim 9, wherein the pressure sensor comprises a first pressure sensor configured to detect an upstream pressure of the hydraulic fluid at a location upstream of the hydraulic motor and further comprising a second pressure sensor configured to detect a downstream pressure of the hydraulic fluid at a location downstream of the hydraulic motor, wherein the monitored pressure parameter comprises a pressure differential between the upstream and downstream pressures.

13. The s agricultural harvester of claim 9, wherein the pressure parameter comprises a sensed pressure of the hydraulic fluid at a given location within the hydraulic circuit.

14. The agricultural harvester of claim 13, further comprising a control valve configured to regulate a flow of the hydraulic fluid to the hydraulic motor and a pump configured to supply the hydraulic fluid to the control valve, the pressure sensor being fluidly coupled to the hydraulic circuit downstream of the pump and upstream of the control valve such that the monitored pressure parameter comprises the sensed pressure of the hydraulic fluid flowing between the pump and the control valve.

15. A method for automatic topper control for an agricultural harvester, the agricultural harvester including a topper assembly having a cutting disk and a rotational drive source coupled to the cutting disk, the method comprising:
controlling an operation of the rotational drive source such that the rotational drive source rotationally drives the cutting disk;
monitoring, with a computing device, a drive-related parameter associated with the operation of the rotational drive source; and
adjusting, with the computing device, a cutting height of the cutting disk based at least in part on the monitored drive-related parameter.

16. The method of claim 15, further comprising comparing the drive-related parameter to at least one predetermined threshold associated with the drive-related parameter; and
wherein adjusting the cutting height of the cutting disk based at least in part on the monitored drive related parameter comprises adjusting the cutting height of the cutting disk when the drive-related parameter differs from the at least one predetermined threshold.

17. The method of claim 16, wherein the at least one predetermined threshold comprises a maximum threshold and a minimum threshold of a predetermined range associated with the drive-related parameter, wherein adjusting the cutting height of the cutting disk when the drive-related parameter differs from the at least one predetermined threshold comprises adjusting the cutting height of the cutting disk when the drive-related parameter falls outside the predetermined range.

18. The method of claim 15, wherein the rotational drive source comprises a hydraulic motor and wherein controlling the operation of the rotational drive source comprises controlling, with the computing device, a supply of hydraulic fluid directed through a hydraulic circuit to the hydraulic motor such that the hydraulic motor rotationally drives the cutting disk, the drive-related parameter comprising a pressure parameter associated with the hydraulic fluid within the hydraulic circuit.

19. The method of claim 18, wherein monitoring the drive-related parameter comprises monitoring a pressure differential across the hydraulic motor.

20. The method of claim 18, wherein monitoring the drive-related parameter comprises monitoring a sensed pressure of the hydraulic fluid at a given location within the hydraulic circuit.
